(19) United States
(12) Patent Application Publication
(10) Pub. No.: US 2006/0242593 A1
(43) Pub. Date: Oct. 26, 2006

(54) Printer emoticon detector & converter

(75) Inventor: Gary Lin Gaebel, Vancouver, WA (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 11/115,812

(22) Filed: Apr. 26, 2005

(51) Int. Cl. G06F 9/00; G06F 17/00

(52) U.S. Cl. 715/771

(57) ABSTRACT

A method for converting emoticons into printer icons includes building a lookup table having emoticon sequences and replacement icons therefore therein; in a print job, determining whether a string of characters comprise a recognizable emoticon sequence, and, if so: replacing the emoticon sequence with a single character printer icon.

### FIELD OF THE INVENTION

This invention relates to conversion of computer graphics, and specifically to a method of converting emoticons to icons.

### BACKGROUND OF THE INVENTION

Sequences of characters like :-) are called “emoticons”. Recent versions of Microsoft Word® provide the capability of detecting emoticons and replacing them with a single symbol or icon. For example, the sequence of characters :-) is replaced with a [symbol] icon. The icons are often a desirable substitute as they are easier to read.

The problem solved by this invention is that emoticons can occur in many types of electronic documents, but the programs that handle those documents often lack emoticon to icon conversion capability. For example, Microsoft Wordpad® does not provide the conversion capability, but is a useful tool for handling simple text documents. Microsoft Outlook® provides no conversion capability for emoticons in received EMail messages. People wishing to have the icon instead of the emoticon in their printed output have no easy way to do the conversion.

The problem is currently solved by doing a cut and paste of the text into a program such as Microsoft Word® so that it can do the conversion before printing. This is inconvenient at best. At worst, it's impossible when the user has no access to MS Word or a similar program that can do the conversion.

U.S. Patent Publication No. US2003/0023425-A1, of Pentheroudakis et al., filed Jan. 30, 2003, for Tokenizer for a natural language processing system, describes a segmenter used in a natural language processing system, which recognizes emoticons as part of language processing, but has no relation to printer software.

Japanese 2004062524 A of Takayuki, published Feb. 26, 2004, describes a mechanism for linking the emotions felt at the time of photography with ordering of the pictures. This invention captures emotions via a sequence of photographs. In the disclosure, emotions are captured via emoticons which are then changed into single character icons.

### SUMMARY OF THE INVENTION

A method for converting emoticons into printer icons includes building a lookup table having emoticon sequences and replacement icons therefore therein; in a print job, determining whether a string of characters comprise a recognizable emoticon sequence, and, if so: replacing the emoticon sequence with a single character printer icon.

It is an object of the invention to provide a method to replace emoticon sequences with single character icons.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

### DETAILED DESCRIPTION OF THE PREFERRED EMBODIMENTS

The invention solves the problem of converting emoticons to icons by adding such a capability to the printer controller software running on the printer. As the software processes the incoming print job data stream, it is a relatively simple matter to search for emoticons and substitute the appropriate icon, plus appropriate white space, to maintain the original layout of the document.

The printing operations of a printer or multi-function peripheral (MFP) are controlled by an embedded microprocessor running under software control. Typically the printer controller software, referred to herein as a “printer controller,” receives print job commands and data from an external source such as a printer driver running on a Windows based PC. The printer controller processes the commands and data to form an exact digital representation of the page to be printed.

The invention includes provision of new code, which is added to the printer controller software. The code has several different components, including a table of the valid emoticon character sequences to be detected. The table also contains single character icons to be used to replace a corresponding emoticon string. Each emoticon may have a unique icon, or several emoticon strings may be replaced by the same icon. For instance, the emoticon strings :) and :-) are replaced by Z,900 ; while the emoticon strings :( and :-( are replaced by [symbol] .

Another component of the invention is an enhancement to the software to enable or disable the emoticon conversion process. Control of the conversion process may be enabled/disabled via a command sequence in the print job stream or via an operator panel button.

A further component of the invention is an enhancement to the software which handles the print data. This code does the actual work of detecting an emoticon string, looking up the string in the table described above, and if the string is found, and conversion is enabled, replacing the string with the single character icon found in the table.

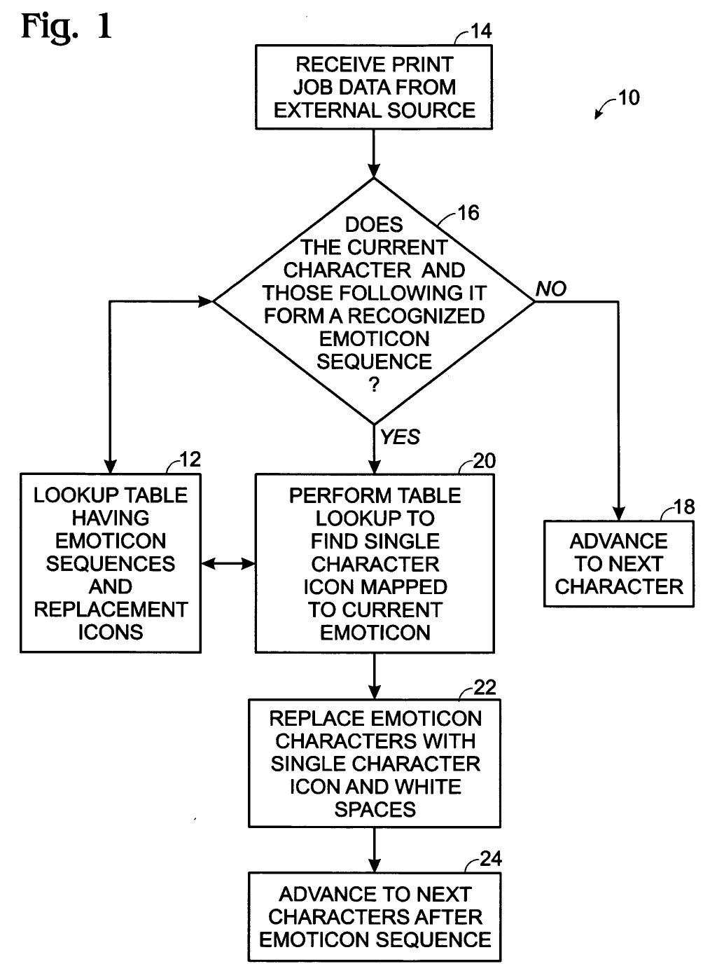

The flow chart of FIG. 1 illustrates the method of the invention, generally at 10, for processing of print job data, assuming that emoticon string conversion is enabled. Initially, a lookup table is provided 12, which lookup table includes emoticon sequences and appropriate replacement icons. A print job is received from a data source, 14. The method of the invention inquires whether the current character, and the characters following, form a recognized emoticon, 16. The system determines this by comparing the current character, and the characters following the current character, to characters in the lookup table. If the character string does not comprise a recognized emoticon sequence, the system advances to the next character in the print job, 18. This may be the results of a character not being part of an emoticon sequence, or the results of a character being part of an emoticon sequence which is not recognizable as such because the emoticon sequence is not in the lookup table.

If the character string comprises a recognized emoticon, the lookup table is again accessed, and the single character icon is located in the lookup table, 20. The emoticon character string is replaced with a single character icon, 22, and the system then advances to the next character following the emoticon sequence, in the print job, 24.

As new emoticon sequences are developed, and new single character icons added to printer characters, the printer controller software may be updated to accommodate the new characters and icons.

Thus, a method for converting emoticons into printer icons has been disclosed. It will be appreciated that further variations and modifications thereof may be made within the scope of the invention as defined in the appended claims.

I claim:

1. A method for converting emoticons into printer icons, comprising:
providing a lookup table having emoticon sequences and replacement icons therefore therein;
in a print job, determining whether a string of characters comprise a recognizable emoticon sequence, and, if so:
replacing the emoticon sequence with a single character printer icon; and
advancing to the next character after the emoticon sequence.

2. The method of claim 1 wherein several emoticon sequences may be replaced by the same printer icon.

3. The method of claim 1 wherein control of the conversion may be enabled/disabled via a command sequence in the print job stream or via an operator panel button.

4. The method of claim 1 which includes, if a character string does not comprise a recognizable emoticon sequence, advancing to the next character.

5. A method for converting emoticons into printer icons, comprising:
providing a lookup table having emoticon sequences and replacement icons therefore therein;
in a print job, determining whether a string of characters comprise a recognizable emoticon sequence, and, if so:
replacing the emoticon sequence with a single character printer icon;
advancing to the next character after the emoticon sequence; and
if a character string does not comprise a recognizable emoticon sequence, advancing to the next character.

6. The method of claim 5 wherein several emoticon sequences may be replaced by the same printer icon.

7. The method of claim 5 wherein control of the conversion may be enabled/disabled via a command sequence in the print job stream or via an operator panel button.

8. A method for converting emoticons into printer icons in printer controller software, comprising:
providing a lookup table having emoticon sequences and replacement icons therefore therein;
in a print job, determining whether a string of characters comprise a recognizable emoticon sequence, and, if so:
replacing the emoticon sequence with a single character printer icon; and
advancing to the next character after the emoticon sequence;
wherein control of the conversion may be enabled/disabled via a command sequence in the print job stream or via an operator panel button.

9. The method of claim 8 wherein several emoticon sequences may be replaced by the same printer icon.

10. The method of claim 8 which includes, if a character string does not comprise a recognizable emoticon sequence, advancing to the next character.
